(19) United States
(12) Patent Application Publication
(10) Pub. No.: US 2006/0196056 A1
(43) Pub. Date: Sep. 7, 2006

(54) Chisels with angled heads and ribbed grip handles

(76) Inventor: Waldon E. Davis, Chester, AR (US)

Correspondence Address: Waldon Edman Davis, 7501 Chester Cutoff, Chester, AR, 72934, US

(21) Appl. No.: 11/073,496

(22) Filed: Mar. 7, 2005

(51) Int. Cl. B25D 3/00

(52) U.S. Cl. 30/167

(57) ABSTRACT

The Ribbed Bar Angled Chisel Punch Set is a set of chisels designed with ribbed or textured handles so the user can grip the tool easier and better. The chisels are angled so that they can perform certain jobs and work in tight spots that ordinary straight shafted chisels cannot. The chisels have many functions. The chisels make it easier for the prying, cutting, punching, pulling and removing of small objects in a limited work space. The chisels in the set are all different and have flat tips, sharp tips, pointed tips, and blunt tips.

### BACKGROUND

1. Field of Invention

The present invention relates to angled chisels useful for performing functions that chisels with straight heads cannot. Angled chisels are an improvement of traditional chisels due to the various benefits of the angled head, which include improvements in prying, cutting, punching, pulling and removing of objects in a limited work space. The angled heads also enable chiseling flat surfaces, for removal of debris, splinters and burrs. The angle allows for the user to place the blade of the chisel close to the work surface and have room between the shaft of the chisel and the work surface for fingers and knuckles.

Chisels are hand tools that concentrate hammer blows into small, sharpened areas and can slice through material with accuracy. The angled chisel is made of tool steel with a rubber or rubber, or rubber-like handle on the chisel shaft. The handle is a molded, gripping device that overcomes frictional slippage. The ribbed rubber handle provides an ergonomic, comfortable and non-slip grip.

A variety of different tip shapes are suitable for different types of jobs. The blade of the head is pressed flat on the surface, like a chisel plane for finishing or paring. Debris, splinters, rough edges and burrs can then be removed easily without hurting ones fingers or knuckles.

2. Description of Prior Art

Various innovations and improvements have been made to the chisel head and shaft to improve function, ergonomics and safety. There is not a chisel that specifically addresses all of the three factors, examples of prior art display an improvement to the chisel head or to the shaft, but not to both. Furthermore, there is not an angled head chisel that has the flexibility of being used with any type of hammer. Most chisels with bent heads can only be used with specific hand tools.

Examples of prior art devices include:

(a) U.S. Pat. No. 4,922,575 refers to an approximately oval elongated cross section in a chisel handle with finger gripping recesses. This device differs from the angled chisels in that, although they have improved rubber handles, they provide no improvement to the chisel head.
(b) Patent Number EP0411470A1 describes a contoured tool handle for a chisel. This handle has an oval cross-section with four finger gripping recesses. The contoured tool handle differs from angled chisels handles, which have a ribbed circular cross-section. In addition, the contoured tool handle does not provide improvement for the chisel head.
(c) U.S. Pat. No. USD313158 relates to an ornamental, removable grip chisel handle. This handle is removable can be placed on different types of chisels. This differs with the angled chisels that have fixed handles. The removable, grip handle does not have ribbing along the whole handle, like the angled chisel handles have.

There continues to be a need for simple, new and improved chisels that can be used in limited work spaces and also allow the user to hold a blade close to flat surfaces leaving room for fingers and knuckles. The improved head on the angled chisels enables chiseling along flat surfaces, and the ribbed handle provides a comfortable and slip-proof grip.

Objects and Advantages

Several objectives and advantages of the present patent are:
(a) to provide a means of chiseling in tight spaces and around corners
(b) to allow for chiseling close to and along flat surfaces while providing room for fingers and knuckles while gripping the chisel.
(c) to provide a comfortable, non-slip grip when chiseling.

### DRAWING FIGURES

In the drawings:

FIGS. 1-5 show front, side and perspective views of the proposed invention with various point styles.

### REFERENCE NUMERALS IN FIGURES

1. Shows the blade of the chisel perpendicular to the long axis of the shaft
2. Shows the angle at which the chisel point deviates from the long axis of the shaft
3. Shows the shaft with comfort grip
4. Shows the blunt end for hammering
5. Shows a cut, perpendicular to the long axis of the shaft
6. Shows a cut, parallel to the long axis of the shaft to form a point with cut, 5.
7. Shows a round Point
8. Shows the round side of combination round and flat point
9. Shows the flat side of combination round and flat point
10. Shows the blade of chisel parallel to the long axis of the shaft

### DESCRIPTION OF THE INVENTION

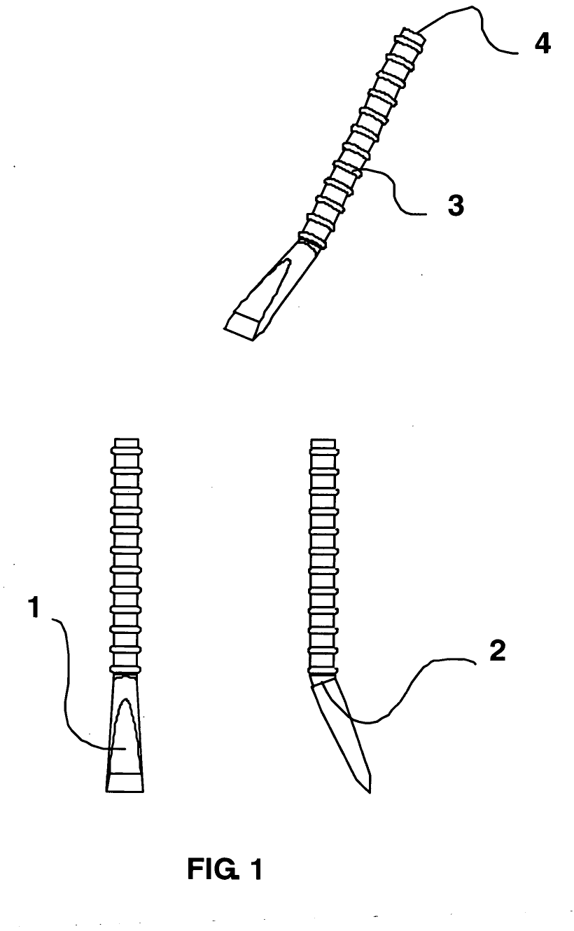

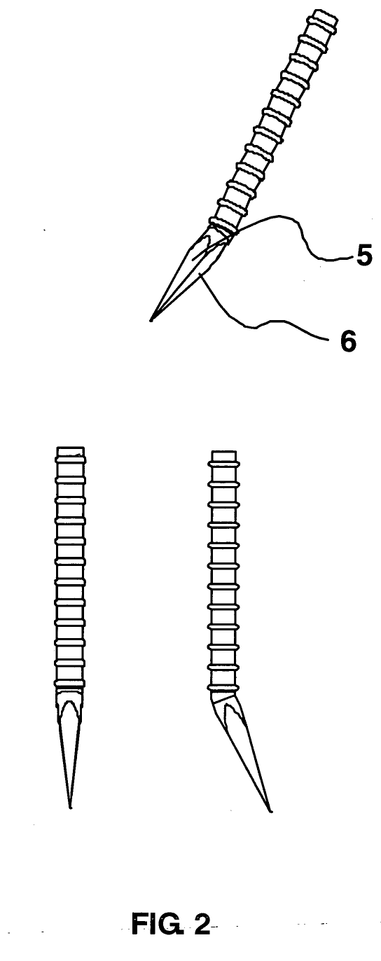

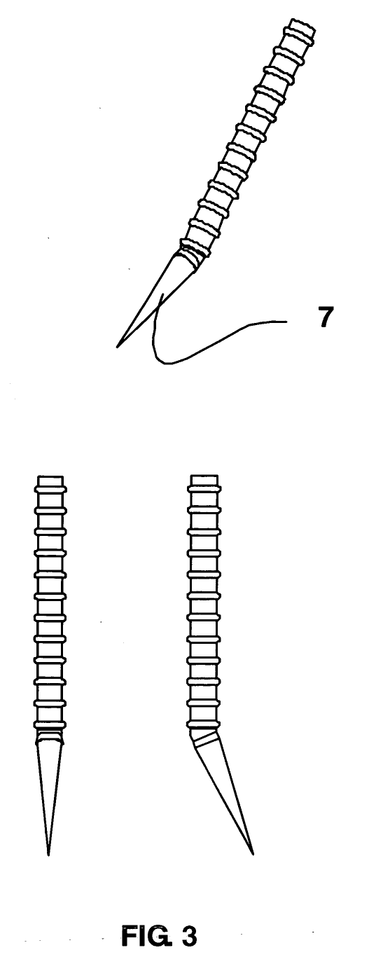

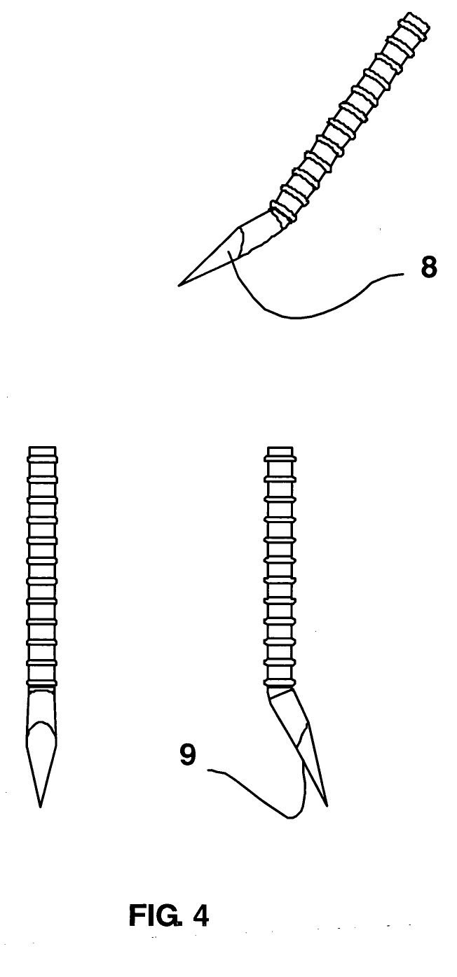

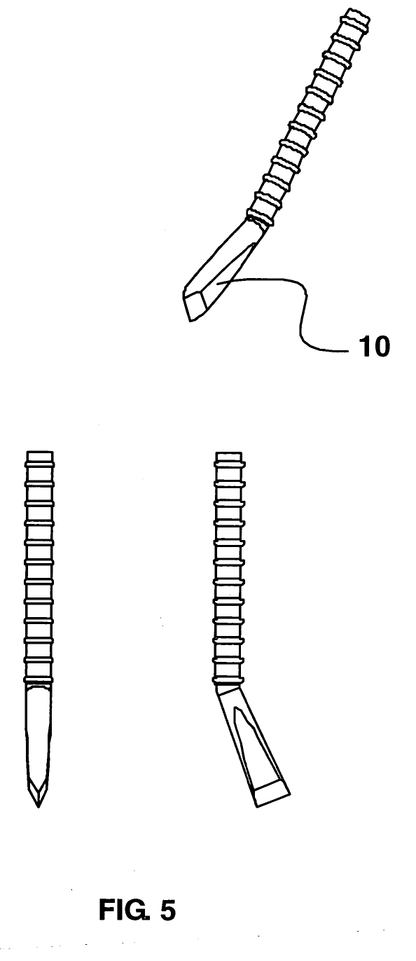

A typical embodiment of the devices is illustrated in FIG. 1 through FIG. 5. There are five different tips shown, each with a tool steel shaft 3 and angle at the end of the shaft and at the beginning of the head 2. The tips include a flat bevel, FIG. 1, a pointed bevel, FIG. 2, a round point, FIG. 3, a combination round and flat, FIG. 4 and a double bevel, FIG. 5. The shafts of the angled chisels are covered with a comfortable rubber grip 3. The hammering occurs at the blunt end of the chisel 4.

### Operation of the Invention

The present invention is an improved chisel with an angled head 2 and a ribbed rubber handle 3 that can be used in limited workspaces or to sheer along a surface, leaving room to hold the shaft. The various shaped tips, 1, 5, 7, 8, 10 allow the user to accomplish a broad rang of tasks. The tool is held at the ribbed handle 3 and a hammer blow is given to the blunt end of the chisel shaft 4. The force from the hammer is transferred to the head 1 through the shaft 3 and angle 2 to cut the material.

A chisel with a blade of the chisel perpendicular to the long axis of the shaft, 1 FIG. 1, provides the ability to cut along a flat surface leaving room to grip the chisel handle without getting fingers and knuckles too close to the surface to grip the handle comfortably. A square point chisel with flat sides perpendicular and parallel to the long axis of the shaft, 5, 6 allow for pointed cutting along a flat surface or in a tight space. The chisel tip variation in FIG. 3 provides a round tip and a point for various tasks. The chisel tip in FIG. 4 provides a flat 9 on the under side of the rounded tip 8. The chisel tip in FIG. 5 provides a blade parallel to the long axis of the shaft for chiseling along a vertical surface or cutting vertically, close to a horizontal surface.

Functions include but are not limited to:

1) ANGLED CHISEL HEAD: Chisel head is angled to allow for use in limited spaces, or for chiseling along flat surfaces.
2) TEXTURED RIBBED GRIP ON CHISEL SHAFT: Rubber grip handle provides a comfortable and slip-proof grip.

1. An angled chisel head

2. A chisel shaft with a non-slip grip

3. In combination, a chisel with an angled head and a non-slip grip on the chisel shaft to provide a means for chiseling along a surface or in tight spaces

4. The device of claim 3 wherein the device provides a means for cutting around corners

5. The device of claim 3 wherein the device provides a means of removing excess material, splinters, or rough edges without hurting ones fingers or knuckles.
